(19) United States
(12) Patent Application Publication
(10) Pub. No.: US 2018/0240351 A1
(43) Pub. Date: Aug. 23, 2018

(54) Vocational Education Portal

(71) Applicant: Amrita Vishwa Vidyapeetham, Tamil Nadu (IN)

(72) Inventors: R. Bhavani Rao, Kerala (IN); Jamie Sara Otelsberg, Agoura Hills, CA (US); Rangasrinivasan Venkataraman, Tamil Nadu (IN)

(21) Appl. No.: 15/962,568

(22) Filed: Apr. 25, 2018

Related U.S. Application Data
(62) Division of application No. 15/193,395, filed on Jun. 27, 2016.
Application No. 15/193,395 is a continuation-in-part of application No. 14/283,587, filed on May 21, 2014, now abandoned.
(60) Provisional application No. 61/838,034, filed on Jun. 21, 2013.

(51) Int. Cl. G09B 5/06; G09B 19/00

(52) U.S. Cl. CPC G09B 5/06; G09B 19/00

(57) ABSTRACT

An educational server system has a computerized server, a plurality of business enterprises in a geographic, a browser-capable computerized appliance, and a user portal accessible by the computerized appliance, including a registration procedure enabling the person to register to services, a content management system (CMS) including aptitude testing for vocational preference, at least one training course compatible with the vocational preference, and vocational aptitude derived from the aptitude testing, wherein the businesses access the CMS via the portal and submit the training courses and employment offers, and the portal enables the person to initiate a search for an employment offer, and wherein the portal is partitioned according to a geography.

### CROSS-REFERENCE TO RELATED APPLICATIONS

The present application is a Divisional application of co-pending application Ser. No. 15/193,395, filed May 27, 2016, which is a Continuation-in-Part application of Ser. No. 14/283,587, filed May 21, 2014 and now abandoned, which claims priority to U.S. Provisional Patent Application Ser. No. 61/838,034, filed Jun. 21, 2013. The disclosures of the parent cases are incorporated herein at least by reference.

### BACKGROUND OF THE INVENTION

### 1. Field of the Invention

The present invention is in the technical field of on-line educational systems. More particularly, the present invention relates to a vocational education portal.

### 2. Description of Related Art

Since the Internet has become widely available, many on-line educational systems have been put into place. On-line educational systems have experienced fast growth and have started to replace physical education systems.

One benefit of on-line educational systems is that the courses and training are available at any time in any location. Students no longer need to travel to a specific classroom site. Another advantage is that the cost of providing on-line educational systems is significantly less than the cost of a traditional classroom education.

As the cost of traditional education continues to rise, many skilled jobs are left unfilled. In the past, vocational schools were available to fill this void. However, vocational schools and training have been continually declining over the last half-century. Consequently, there is a need for an on-line educational system that provides vocational training for unemployed and underemployed persons, as a means for enterprises to prepare and recruit qualified persons.

### BRIEF SUMMARY OF THE INVENTION

In an embodiment of the invention an educational server system is provided, comprising a computerized server connected to a wide-area network, coupled to a data repository and having a processor executing software from a non-transitory medium, a plurality of business enterprises each having a place of business in a specific geographic region and computer access on the wide-area network to the computerized server, a browser-capable computerized appliance connected to the wide-area network and usable by a person, and a user portal provided by the software and accessible by the browser-capable computerized appliance, the portal including a registration procedure enabling the person to register for services provided by the computerized server, the registration procedure determining at least identification of the person, and a vocational preference, if any, for the person, and a content management system (CMS) including an aptitude testing procedure, the aptitude testing procedure enabling determination of the vocational preference for the person at least one training course in the data repository that is compatible with the person's stated vocational preference or determined vocational aptitude derived from the aptitude testing, wherein the third-party businesses access the CMS via the portal and submit and store the training courses and employment offers and the portal enables the person to access the portal, initiate a search procedure for an employment offer, and wherein the portal is partitioned according to a geolocation of the browser-capable computerized appliance, only providing results of the search for employment offers and training courses provided to the CMS by the businesses having a geolocation that matches the geolocation of the person.

In one embodiment the system further comprises an evaluation procedure as a part of the training course in which the first person is engaged, the evaluation procedure determining and storing a performance level for the person. Also, in one embodiment,

[symbol]

If the performance attains a preset threshold level, the person and a business enterprise sharing the same geographic region, and which enterprise is associated with the training course, are connected, enabling the person and a representative of the enterprise to communicate. Also, in one embodiment the training courses comprise one or more of audio files, videos, and text documents. And in one embodiment the audio files, videos and text documents may be downloaded from the data repository by the person and used off-line.

In one embodiment of the system, in the evaluation procedure, a certification is created and stored, attesting to achievement of mastery of the training course by the person, and is made accessible by the person to be downloaded. Also, in one embodiment the system further comprises a procedure establishing a mentor program between the business enterprise and the person. Also, in one embodiment the system further comprises a procedure for engaging the person as an employee of the business enterprise.

In another aspect of the invention a method provided by an educational server system is provided, comprising the steps of (a) connecting a computerized server to a wide-area network, coupled to a data repository and having a processor executing software from a non-transitory medium, (b) providing a portal by the software at the server enabling persons and businesses to access the portal via computerized appliances connected to the wide area network, (c) providing a registration procedure at the portal enabling the person to register to services provided by the computerized server, the registration procedure determining at least identification of the person, and a vocational preference, if any, for the person or providing an aptitude testing procedure for the person to determine a vocational preference, (d) accessing a content management system (CMS) by the businesses via the portal submitting and storing at least the training courses and employment offers, (e) partitioning the portal according to a geolocation of the computerized appliance used by the person to access the portal (f) performing a search by the person a the portal for at least one employment offer and training course in the data repository that is compatible with the person's stated vocational preference or determined, vocational aptitude derived from the aptitude testing, and (g) only providing results of the search for employment offers and training courses provided to the CMS by the businesses having a geolocation that matches the geolocation of the person based upon the partitioning of step (e).

In one embodiment the method further comprises executing an evaluation procedure as a part of the training course in which the person is engaged, the evaluation procedure determining and storing a performance level for the person. Also, in one embodiment, if the performance level attains a preset threshold level, the person and at least one of the businesses sharing the same portal partition, and the at least one of the businesses is associated with the training course are connected with the person, enabling the person and a representative of the enterprise to communicate. Also, in one embodiment the training courses are developed by and provided by individual ones of the business enterprises. And in one embodiment the training courses comprise one or more of audio files, videos, and text documents.

In one embodiment of the method the audio files, videos and text documents may be downloaded from the data repository by the person and used off-line. Also, in one embodiment, in the evaluation procedure, a certification is created and stored, attesting to achievement of mastery of the training course by the person, and is made accessible by the person to be downloaded. Also, in one embodiment the method further comprises a procedure establishing a mentor program between the business enterprise and the person. In one embodiment the method further comprises a procedure engaging the person as an employee of the business enterprise. And in one embodiment, in step (d), a learning management system, advertising management system and job management system are accessed by the businesses.

### BRIEF DESCRIPTION OF THE SEVERAL VIEWS OF THE DRAWINGS

FIG. 1 is an architectural diagram of an Internet computer network system according to an embodiment of the present invention.

FIG. 2 is a flow diagram illustrating steps a student may take to utilize the vocational education portal according to an embodiment of the present invention.

FIG. 3 is a flow diagram illustrating steps wherein local businesses may train and recruit qualified skilled workers by utilizing the vocational education portal according to an embodiment of the present invention.

FIG. 4 is an architectural diagram of an Internet computer network system with a plurality of applicants and business enterprises connecting to the network system via an Internet service provider according to an embodiment of the present invention.

FIG. 5 is a block diagram showing the executable processes within the vocational educational portal software according to an embodiment of the present invention.

FIG. 6 is an expanded flow diagram illustrating steps a student may take to utilize the vocational educational portal according to an embodiment of the present invention.

### DETAILED DESCRIPTION OF THE INVENTION

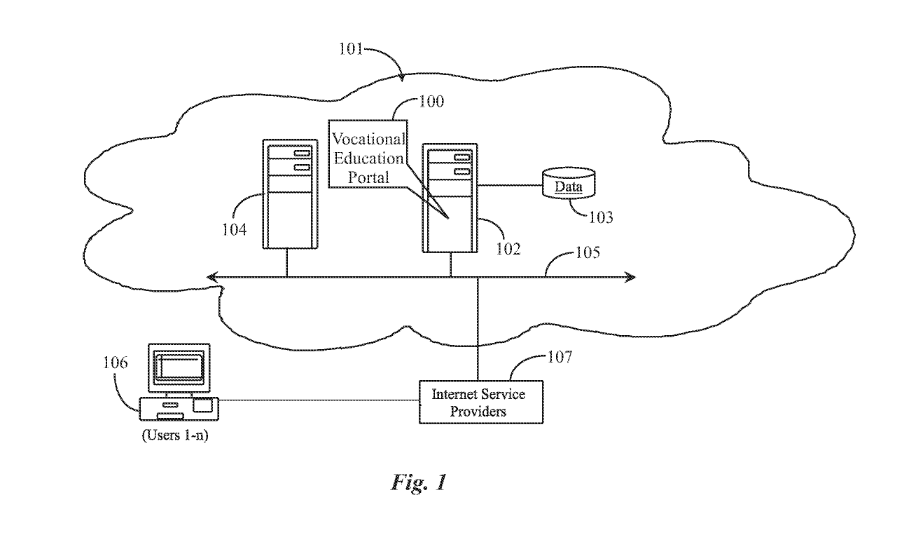

FIG. 1 is an architectural diagram of an Internet-connected computer system according to an embodiment of the present invention. The Internet-connected system comprises one or more servers 102 in Internet network 101, having one or more processors executing vocational education portal software 100 from non-transitory media. Server 102 is connected to a data repository 103, which may be any sort of data storage known in the art. The system further comprises a third party Internet-connected server 104 connected to Internet backbone 105. Although one third party Internet-connected server 104 is shown, it is understood that potentially millions of other similar servers are connected to the Internet via Internet backbone 105. A number of users (1-n) 106 are connected to the Internet-connected server via an Internet service provider (ISP) 107, representing all of the ways that persons may connect to the Internet, allowing users 106 to access the vocational education portal. Users may be a variety of entities, including but not limited to, unskilled and semi-skilled persons, students, teachers, governments, guilds, education institutions, content providers, businesses, and non-government organizations (NGOs).

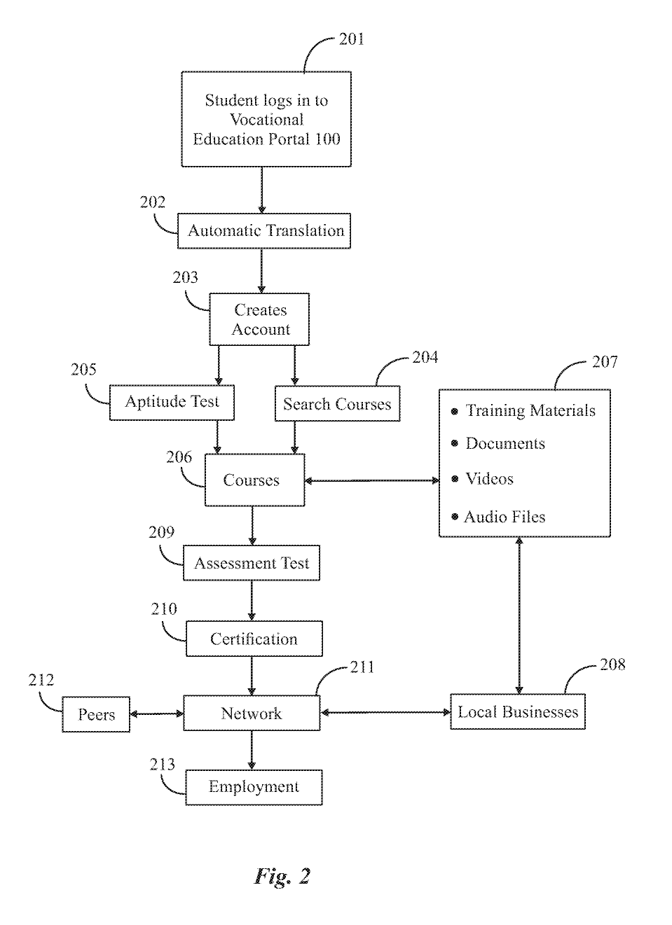

FIG. 2 is a flow diagram illustrating steps a student may take to utilize the vocational education portal. At step 201 a student logs in to vocational education portal 100. The student may be any semi-skilled, unskilled, or marginalized person, chronically unemployed and the like. The portal may be accessible from regional vocational centers or remotely. Remote access is available from a variety of devices and technology platforms, including but not limited to, desktop computers, laptops, tablets, and smartphones. This allows students to access the portal from essentially any location.

In step 202, which is an optional step, the language of the portal is automatically translated into the regional language of the student. The language selection in some embodiments is based on the geolocation from where the portal is being accessed. The student will also have the ability to select a specific language, and in response the portal will present interfaces to the student in the selected language. In step 203, the student registers and creates an account, as is well known in the art. If the student has a specific trade or specific skill they wish to expand, they may search courses 204 available for that specific trade or vocation. Alternatively, if the student does not have a specific trade in mind, the portal may recommend a trade and competency level based on the results of an aptitude test 205.

Next, in step 206, the student may register for courses. Once registered, the student has access to a plurality of resources 207, including training materials, documents, videos, and audio files. The resources further include video lectures, interactive multimedia workbooks, an interactive 3D glossary, simulation training and evaluations. The courses and corresponding resources 207 are created and provided by businesses 208. This ensures potential employees are trained proficiently. In one embodiment the portal is partitioned by geolocation so that local businesses may create course to be accessed by local students, and later employment features may be used to match students with open employment opportunities locally, such that students may not have to relocate to accept employment opportunities.

After completion of courses 206, the student is given an assessment test 209, which tests the student's competency levels for the specific trade. Once the student successfully passes the assessment test, the student is provided a certification 210. The certification allows the student to gain credibility for potential employers. Likewise, the certification allows the standardization of skill levels across multiple communities and countries to meet international standards.

In the circumstance wherein a student does not pass the assessment test or tests, that student may be invited to register for one or more classes that may be designed to address exactly those areas where the student may have fallen short of competency on the assessment tests.

Still referring to FIG. 2, the student has access to a network 211, which connects local businesses 208 to certified students in an employment sub-system. From this network the student may gain internships or employment 213 from local businesses seeking certified students in a specific trade. Likewise, the student may network with peers 212 to further their skills and career by searching for other employment opportunities online. The network includes, in some embodiments, an ability to be interfaced and fully-integrated with existing social media sites, so students may access the functionality of the portal through their own networking space.

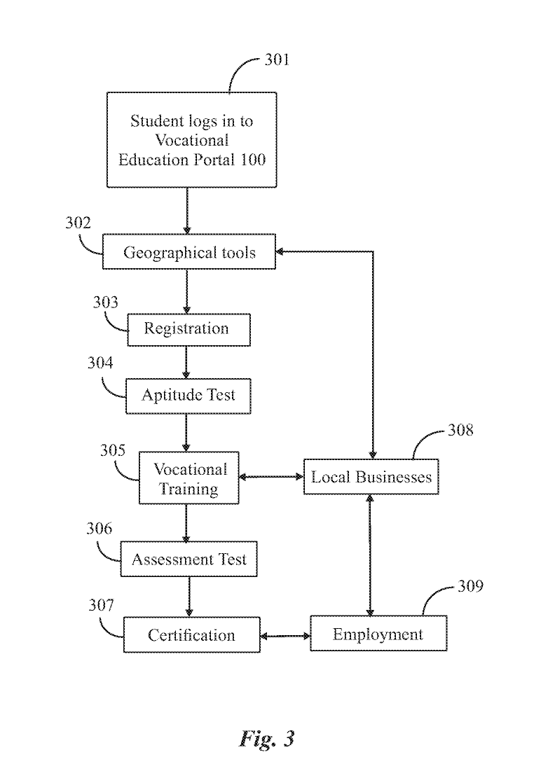

FIG. 3 is a flow diagram illustrating steps wherein local businesses 308 may train and recruit qualified workers by utilizing the vocational education portal. In step 301, a student logs in to vocational education portal 100. Next, geographical tools 302 are initiated. Specifically, the language selection as the medium of learning may be provided based on the location from where the portal is being accessed. Once the student registers at step 303, the student is directed to vocational training 305 based on the results of an aptitude test 304. The vocational training is provided by local businesses 308 and is specific to their own businesses. The group of available businesses is provided by the geographical tools and the corresponding geolocation of the student. This ensures that employers in need of qualified workers may train students in a specific trade necessary for employment in their businesses. An assessment test 306 is given to students to quantify their competency level for a specific trade. Once a pre-determined competency level is reached, the student will gain certification 307 for that specific trade.

After a student is certified, they may be recruited for employment 309 from the same local businesses that provided the vocational training, or from other businesses. This ensures an aid to the local economy, as the local region will retain the qualified workers, lowering unemployment rates and boosting the economy.

In some embodiments the portal will include a robust Learning Management System (LMS) and further a robust Content Management System (CMS), Certification management system, User management System (UMS), Advertisement management system, Job management system, video conferencing and social networking. The CMS allows for community, industry and education providers to add to the content pool by adding their own content that may be rated and reviewed by the community.

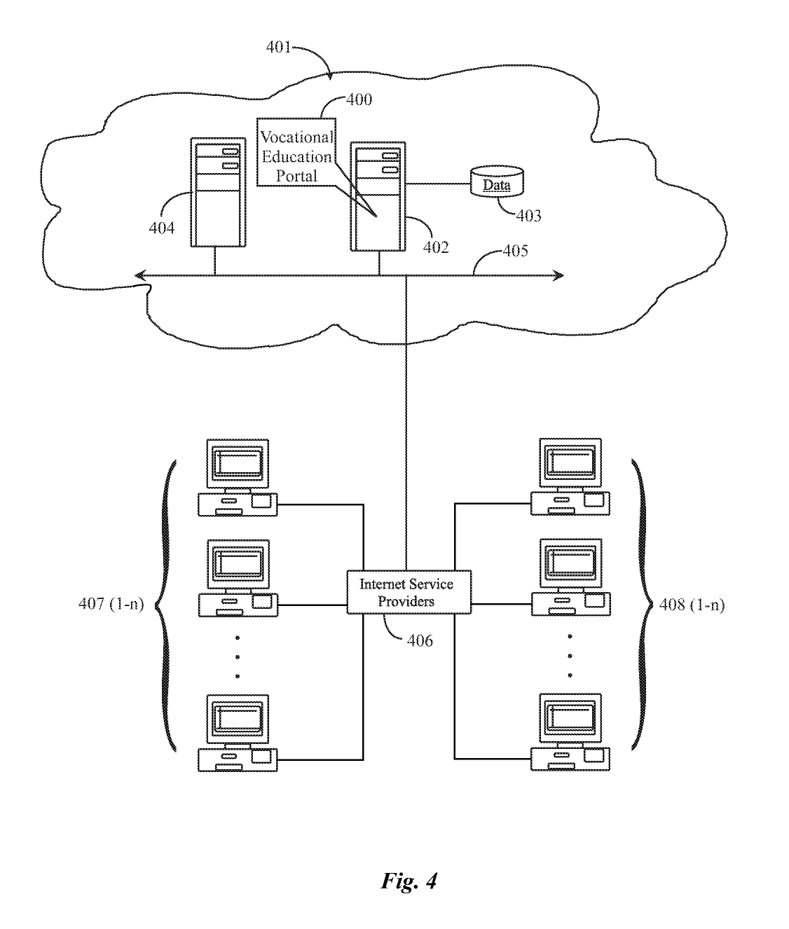

FIG. 4 is an architectural diagram of an Internet computer network system with a plurality of applicants and business enterprises connecting to the network system via an Internet service provider according to an embodiment of the present invention. The Internet-connected system comprises one or more servers 402 in Internet network 401, having one or more processors executing vocational education portal software 400 from non-transitory media. Server 402 is connected to a data repository 403, which may be any sort of data storage known in the art. The system further comprises a third party Internet-connected server 404 connected to Internet backbone 405. Although one third party Internet-connected server 404 is shown, it is understood that potentially millions of other similar servers are connected to the Internet via Internet backbone 405. A number of applicants (1-n) 407 are connected to the Internet-connected server via an Internet service provider (ISP) 406. Applicants 407 may sign up, search for courses, take courses, and take tests to prove their worthiness based on their vocational preference. A number of business enterprises (1-n) 408 are also connected to the Internet-connected server via an ISP 406. Business enterprises 408 may provide training material or create courses that are accessible to applicants 407, or search for suitable candidates amongst applicants 407 to fill open positions.

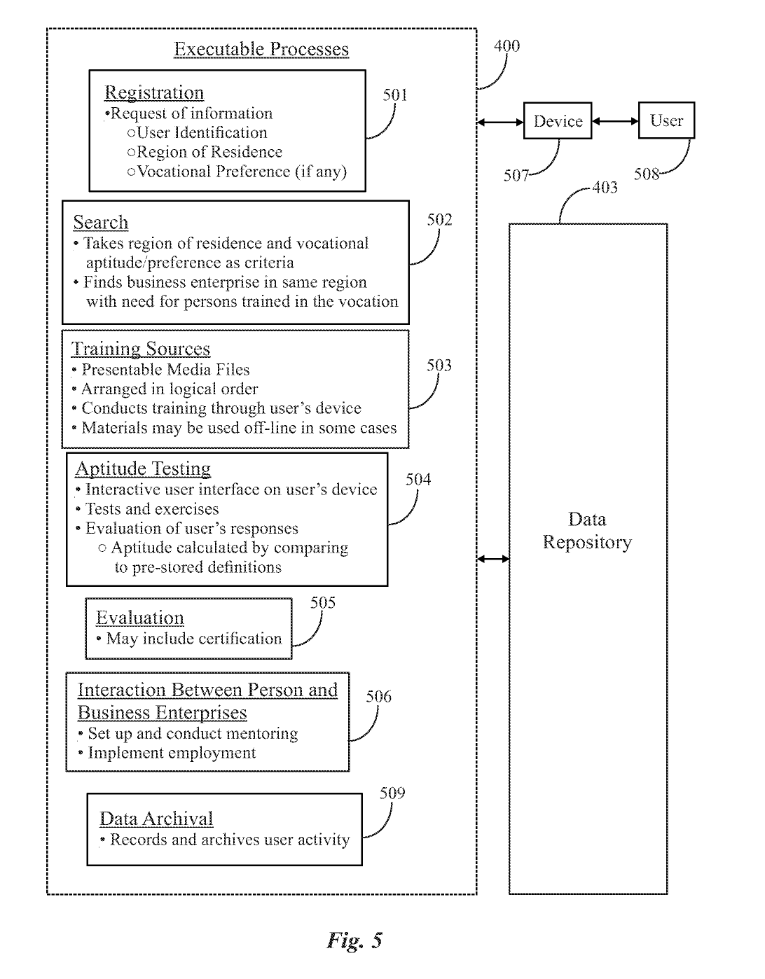

FIG. 5 is a block diagram showing the executable processes within the vocational educational portal software 400 according to an embodiment of the present invention. The procedures are not limited to run in any particular order. Portal software 400 provides an interface to a user device 507 for a user 508 to interact with portal software 400. Although only a single device-user set is shown, it is understood that potentially millions of users can be connected concurrently to the portal through their device 507. Device 507 may be a variety of entities, including but not limited to, a desktop computer, a laptop, a mobile phone, or a tablet device. This allows user 508 to access the portal from essentially any location. User 508 may be a variety of entities, including but not limited to, unskilled and semi-skilled persons, students, teachers, governments, guilds, education institutions, content providers, businesses, and non-government organizations.

A registration procedure 501 prompts the user for identification, vocational preference if any, and region of residence. Alternatively, the region can be auto-detected using methods that are well-known in the art. A search procedure 502 uses the regional, and vocational preference from registration process 501 as search criteria to direct the user to recommended courses, training material, or business enterprise listings for open positions. A training procedure 503 manages presentable media files that user 508 may access via device 507. Training material is stored on and read from data repository 403. The media files may consist of, but are not limited to, audio files, videos, and text documents. Training procedure 503 may arrange training material in a logical order as to allow a user 508 to build up skill gradually. In some cases, training material may be saved (downloaded) for off-line usage. A testing procedure 504 serves interactive tests and exercises to user 508 via device 507. Testing procedure 504 may be executed after registration in absence of a vocational preference. Aptitude is calculated through comparison to pre-stored definitions. An evaluation procedure 505 determines the performance level of user 508. Certification may be granted to attest for mastery of a training course, and is made accessible to be downloaded. A matchmaking procedure 506 provides an interface for user 508 and business enterprises to connect. Matchmaking procedure 506 may be used to set up and conduct a mentoring relationship, or to provide employment opportunities, among potentially other purposes. A data archival procedure 509 records and stores user activity history onto data repository 403.

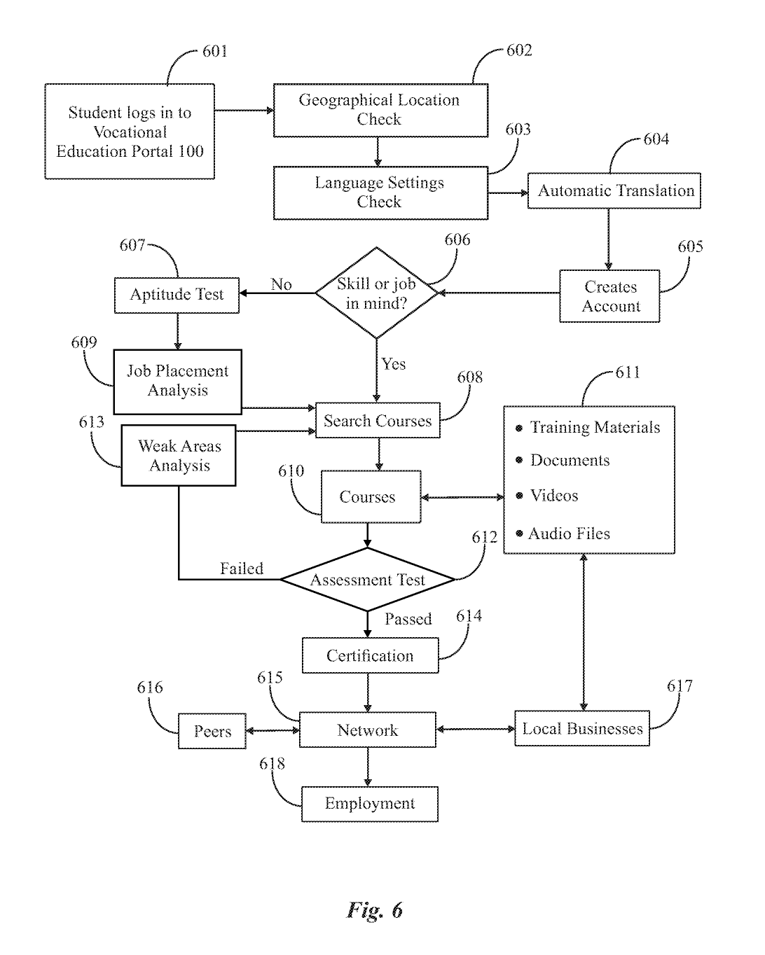

FIG. 6 is an expanded flow diagram illustrating steps a student may take to utilize the vocational educational portal according to an embodiment of the present invention. At step 601 a student logs in to vocational education portal 400. The student may access the portal remotely via device 507, or from regional vocational centers.

At step 602, geographical location is determined automatically using any one of a wide range of tools known in the art for this purpose. One example would be IP geolocation lookup. At step 603, the language setting may be automatically determined through language settings commonly broadcasted from devices and web browsers upon connection to a web server. At step 604, vocational education portal 400 interfaces are automatically translated into the language acquired from the language setting. The user may also pick any other supported language of their choosing. At step 605, the user may be greeted with a registration form. The user is expected to fill out their identification information. The location may be filled in automatically if the data is available, otherwise, the user can fill it in themselves or change it to their region of choice. At step 606, the user is to make a choice on whether they have a skill or job in mind before proceeding. If the user answers “No” they are directed to step 607 to complete an aptitude test. After completion and submission of their responses, the system calculates an aptitude score based on pre-stored definitions. The aptitude score is passed on to step 608, and the user is presented with a list of courses to prepare them for a job they have been determined to match well with by the vocational education portal software 400.

Returning to step 606, if the user responds with “Yes” they are taken directly to step 608, where they may enter a set of search criteria to find their desired courses. At step 610, the user may access the courses that have been narrowed down by step 608. The course material 611 is provided by a number of local businesses 617, that is, businesses in the same region as the student. Course material may consist of, but is not limited to, text documents, videos, and audio files. After completion of a course curriculum, the user is given a chance to take an assessment test at step 612. In the event of an unsatisfactory grade, vocational education portal software 400 evaluates the completed test at step 613 and provides the user with another list of recommended courses to work on the areas that they in which they underperformed.

Returning to step 612, in the event of a passing grade, at step 614 the user will be granted a certificate, attesting to their achievement of mastery of the training course. At step 615, the user has access to a network in which they may connect with any number of peers 616, or any number of local businesses 617. At step 618, the user finds employment.

It will be apparent to one with skill in the art, that the embodiments described above are specific examples of a single broader invention which may have greater scope than any of the singular descriptions taught. There may be many alterations made in the descriptions without departing from the spirit and scope of the present invention.

What is claimed is:

1. An educational server system, comprising:
a computerized server connected to a wide-area network, coupled to a data repository and having a processor executing software from a non-transitory medium;
a plurality of business enterprises each having a place of business in a specific geographic region and computer access on the wide-area network to the computerized server;
a browser-capable computerized appliance connected to the wide-area network and usable by a person;
a user portal provided by the software and accessible by the browser-capable computerized appliance, including:
a registration procedure enabling the person to register to services provided by the computerized server, the registration procedure determining at least identification of the person, and a vocational preference, if any, for the person; and
a content management system (CMS) including an aptitude testing procedure, the aptitude testing procedure enabling determination of the vocational preference for the person at least one training course in the data repository that is compatible with the person's stated vocational preference or determined vocational aptitude derived from the aptitude testing;
wherein, the third-party businesses access the CMS via the portal and submit and store the training courses and employment offers and the portal enables the person to access the portal, initiate a search procedure for an employment offer, and wherein the portal is partitioned according to a geolocation of the browser-capable computerized appliance, only providing results of the search for employment offers and training courses provided to the CMS by the businesses having a geolocation that matches the geolocation of the person.

2. The system of claim 1 further comprising an evaluation procedure as a part of the training course in which the first person is engaged, the evaluation procedure determining and storing a performance level for the person.

3. The system of claim 2 wherein, if the performance attains a preset threshold level, the person and a business enterprise sharing the same geographic region, and which enterprise is associated with the training course, are connected, enabling the person and a representative of the enterprise to communicate.

4. The system of claim 1 wherein the training courses comprise one or more of audio files, videos, and text documents.

5. The system of claim 4 wherein the audio files, videos and text documents may be downloaded from the data repository by the person and used off-line.

6. The system of claim 2 wherein, in the evaluation procedure, a certification is created and stored, attesting to achievement of mastery of the training course by the person, and is made accessible by the person to be downloaded.

7. The system of claim 3 further comprising a procedure establishing a mentor program between the business enterprise and the person.

8. The system of claim 3 further comprising a procedure for engaging the person as an employee of the business enterprise.

9. A method provided by an educational server system, comprising the steps of:
(a) connecting a computerized server to a wide-area network, coupled to a data repository and having a processor executing software from a non-transitory medium;
(b) providing a portal by the software at the server enabling persons and businesses to access the portal via computerized appliances connected to the wide area network;
(c) providing a registration procedure at the portal enabling the person to register to services provided by the computerized server, the registration procedure determining at least identification of the person, and a vocational preference, if any, for the person or providing an aptitude testing procedure for the person to determine a vocational preference;
(d) accessing a content management system (CMS) by the businesses via the portal submitting and storing at least the training courses and employment offers;
(e) partitioning the portal according to a geolocation of the computerized appliance used by the person to access the portal;
(f) performing a search by the person a the portal for at least one employment offer and training course in the data repository that is compatible with the person's stated vocational preference or determined, vocational aptitude derived from the aptitude testing; and
(g) only providing results of the search for employment offers and training courses provided to the CMS by the businesses having a geolocation that matches the geolocation of the person based upon the partitioning of step (e).

10. The method of claim 9 further comprising executing an evaluation procedure as a part of the training course in which the person is engaged, the evaluation procedure determining and storing a performance level for the person.

11. The method of claim 10 wherein, if the performance level attains a preset threshold level, the person and at least one of the businesses sharing the same portal partition, and the at least one of the businesses is associated with the training course are connected with the person, enabling the person and a representative of the enterprise to communicate.

12. The method of claim 9 wherein the training courses are developed by and provided by individual ones of the business enterprises.

13. The method of claim 9 wherein the training courses comprise one or more of audio files, videos, and text documents.

14. The method of claim 13 wherein the audio files, videos and text documents may be downloaded from the data repository by the person and used off-line.

15. The method of claim 10 wherein, in the evaluation procedure, a certification is created and stored, attesting to achievement of mastery of the training course by the person, and is made accessible by the person to be downloaded.

16. The method of claim 11 further comprising a procedure establishing a mentor program between the business enterprise and the person.

17. The method of claim 10 further comprising a procedure engaging the person as an employee of the business enterprise.

18. The method of claim 2, wherein in step (d) a learning management system, advertising management system and job management system are accessed by the businesses.
